(19) United States
(12) Patent Application Publication
(10) Pub. No.: US 2012/0189880 A1
(43) Pub. Date: Jul. 26, 2012

(54) ELECTROCHEMICAL POWER DELIVERY VOLTAGE REGULATOR

(75) Inventors: Gerhard Ingmar Meijer, Zurich (CH); Patrick Ruch, Jenins (CH)

(73) Assignee: International Business Machines Corporation, Armonk, NY (US)

(21) Appl. No.: 13/351,252

(22) Filed: Jan. 17, 2012

(30) Foreign Application Priority Data
Jan. 20, 2011 (EP) 11151577.1

(51) Int. Cl. H01M 8/20; H01M 2/40

(52) U.S. Cl. 429/51; 429/105; 429/70

(57) ABSTRACT

An electrochemical power delivery voltage regulator. The regulator includes one or more fluid circuits having a first electrolyte solution with a primary redox couple and a secondary redox couple; and a second electrolyte solution with a further primary redox couple; a polyelectrode in contact with the first electrolyte solution; a further electrode in contact with the second electrolyte solution; and control means coupled to control a relative concentration of electroactive species of the secondary redox couple and thereby impact a mixed potential at the polyelectrode, such as to regulate a supply voltage of the electrochemical power delivery voltage regulator, in operation. The invention further concerns a corresponding method of voltage regulation and a system comprising such an electrochemical power and electrical consumers with consumer fluid circuits in fluid communication with respective one or more fluid circuits of the electrochemical power delivery voltage regulator.

### CROSS REFERENCE TO RELATED APPLICATION

This application claims priority under 35 U.S.C. 119 from European Application 11151577.1, filed Jan. 20, 2011, the entire contents of which are incorporated herein by reference.

### BACKGROUND OF THE INVENTION

1. Field of the Invention

The present invention relates to power delivery systems, and more particularly to voltage regulation of power supplied by such systems to external consumers.

2. Background of the Invention

A flow battery is a special type of rechargeable battery that contains an electrolyte solution with one or more dissolved electroactive species. The dissolution of active species in solution allows for the external storage of the reactants, thereby preventing self-discharge, as is normally observed in primary and secondary battery systems. In flow batteries, electroactive species flow through an electrochemical cell that converts chemical energy into electricity. Additional electrolyte can be stored externally, which can for example be pumped through the cell. Flow batteries can be rapidly recharged by replacing the electrolyte liquid and re-energizing the spent material. In flow batteries, the chemical reaction involved is often reversible so they can be recharged without replacing the electroactive material. Typical flow batteries require pumps, sensors, control units and secondary containment vessels.

Examples of redox flow batteries are vanadium batteries. Vanadium redox batteries typically consist of power cells in which the two electrolytes are separated by a proton exchange membrane. In such batteries, both electrolytes are vanadium based: the electrolyte in the positive half-cells contains VO₂⁺ and VO²⁺ ions, while in the negative half-cells, the electrolyte contains V³⁺ and V²⁺ ions. Both half-cells are connected to storage tanks: pumps are provided which can circulate electrolytes through the cells. When the battery is charged, the VO²⁺ ions in the positive half-cell are converted to VO₂⁺ ions (electrons being removed from the positive electrode). Similarly in the negative half-cell, introducing electrons converts V³⁺ into V²⁺ ions. This process can be reversed at discharge. The voltage provided by flow batteries is primarily determined by the choice of redox species and varies little with the depletion of the redox species during discharge. Some electrical devices, for example modern microprocessors, require voltage regulation and such batteries can be problematic.

### BRIEF SUMMARY OF THE INVENTION

In order to overcome these deficiencies, the present invention provides an electrochemical power delivery voltage regulator, including: one or more fluid circuits including a first electrolyte solution with a primary redox couple and a secondary redox couple; and a second electrolyte solution with a further primary redox couple; a polyelectrode in contact with the first electrolyte solution; a further electrode in contact with the second electrolyte solution; and control means coupled to the polyelectrode and the further electrode to control a relative concentration of electroactive species of the secondary redox couple and impact a mixed potential at the polyelectrode to regulate a supply voltage of the electrochemical power delivery voltage regulator.

According to another aspect, the present invention provides a system, including: an electrochemical power delivery voltage regulator including: one or more fluid circuits including a first electrolyte solution with a primary redox couple and a secondary redox couple; and a second electrolyte solution with a further primary redox couple; a polyelectrode in contact with the first electrolyte solution; a further electrode in contact with the second electrolyte solution; and control means coupled to the polyelectrode and the further electrode to control a relative concentration of electroactive species of the secondary redox couple and impact a mixed potential at the polyelectrode to regulate a supply voltage of the electrochemical power delivery voltage regulator; at least one electrical consumers, each having: at least one consumer fluid circuits in fluid communication with respective one or more fluid circuits of the electrochemical power delivery voltage regulator; and electrodes in contact with respective electrolyte solutions in the one or more consumer fluid circuits.

According to yet another aspect, the present invention provides a method of voltage regulation, including: providing an electrochemical power delivery voltage regulator including: one or more fluid circuits including a first electrolyte solution with a primary redox couple and a secondary redox couple; and a second electrolyte solution with a further primary redox couple; a polyelectrode in contact with the first electrolyte solution; a further electrode in contact with the second electrolyte solution; and control means coupled to the polyelectrode and the further electrode to control a relative concentration of electroactive species of the secondary redox couple and impact a mixed potential at the polyelectrode to regulate a supply voltage of the electrochemical power delivery voltage regulator; and controlling, via the control means, a concentration of the secondary redox couple to impact a mixed potential applied at the polyelectrode and thereby regulate the supply voltage of the power delivery system.

### BRIEF DESCRIPTION OF THE SEVERAL VIEWS OF THE DRAWINGS

FIG. 1 schematically depicts an electrochemical voltage regulator, according to embodiments of the present invention;

FIG. 2 shows the current-potential characteristic of an electrode in contact with the redox couple V³⁺/V²⁺;

FIG. 3 is the current-potential characteristic of an electrode in contact with the redox couple Fe³⁺/Fe²⁺;

FIG. 4 is a typical current-potential characteristic of a polyelectrode in contact with a primary redox couple (V3+/V²⁺) and a secondary redox couple (Fe³⁺/Fe²⁺), as involved in embodiments;

FIG. 5A shows a typical current-potential curve for the polyelectrode, where the redox couples involved are V³⁺/V²⁺ and Fe³⁺/Fe²⁺);

FIG. 5 B shows a typical current-potential curve for a further electrode, with the corresponding redox couple being VO₂⁺/VO²⁺;

FIG. 6A shows another current-potential curve for the polyelectrode corresponding to different surface concentrations of redox couples, and as obtained in embodiments;

FIG. 6B shows another current-potential curve for the further electrode, corresponding to different surface concentrations of redox couples, and as obtained in embodiments;

FIG. 7 depicts a connection scheme of the electrochemical voltage regulator of FIG. 1 with a multitude of electrical consumers; and

FIG. 8 is a flowchart depicting high-level steps of a method according to embodiments of the invention.

Note that details shown in the accompanying drawings may be deliberately exaggerated, simplified or omitted, for the sake of conciseness or pedagogy.

### DETAILED DESCRIPTION OF THE PREFERRED EMBODIMENTS

As an introduction, a general aspect of the invention directed to an electrochemical voltage regulator including a polyelectrode and a further electrode, which are used as a voltage regulator for electrical consumers connectable thereto, is first described. The polyelectrode and the further electrode are in contact with their respective electrolyte solutions and control means are provided to influence the fluid composition. In one embodiment, the control means regulate a supply voltage of the regulator, and the fluid composition can for instance be modified with a control signal (e.g., electrical) that controls the electrochemical conversion of electroactive species.

Various embodiments of the present invention can be contemplated, as is discussed below. Amongst other advantages they provide, one can make note of the following:
The electrochemical regulator can provide supply voltage regulation for an electrochemical power-delivery system supplying power to electrical consumers, e.g., microprocessors. In that respect, being able to adjust the supply voltage of circuit components enables the reduction of both active power and passive power, leading to improved computing efficiency. Notably, the electrochemical regulator can provide a supply voltage regulation over a large voltage-range, e.g., 1 V;
The supply voltage does not need to be over-provisioned. Supply voltage regulation can be provided for electrical consumers with multiple supply voltage levels. In addition, supply voltage regulation can be provided for electrical consumers with intermittent load. In that respect, circuit architectures have been introduced for microprocessors that allow the power associated with computational processes and also with the leakage power to be adapted. The microprocessor supply voltage (and concomitantly its frequency) can be adjusted and circuit blocks can be temporarily powered down when not in use;
The arrangement of electrical clients can be chosen in parallel or in series, with the electrochemical regulator being provided upstream with respect to the clients to ensure individual voltage regulation;
Electrochemical redox couples can be chosen from a substantially increased selection of materials because redox couples with otherwise unsuitable equilibrium potentials can now be utilized; and
The electrochemical element can adjust supply voltage, and this is at least partly independently from fluid flow velocity. Supply voltage and cooling performance for electrical clients can thus be adjusted independently, to some extent.

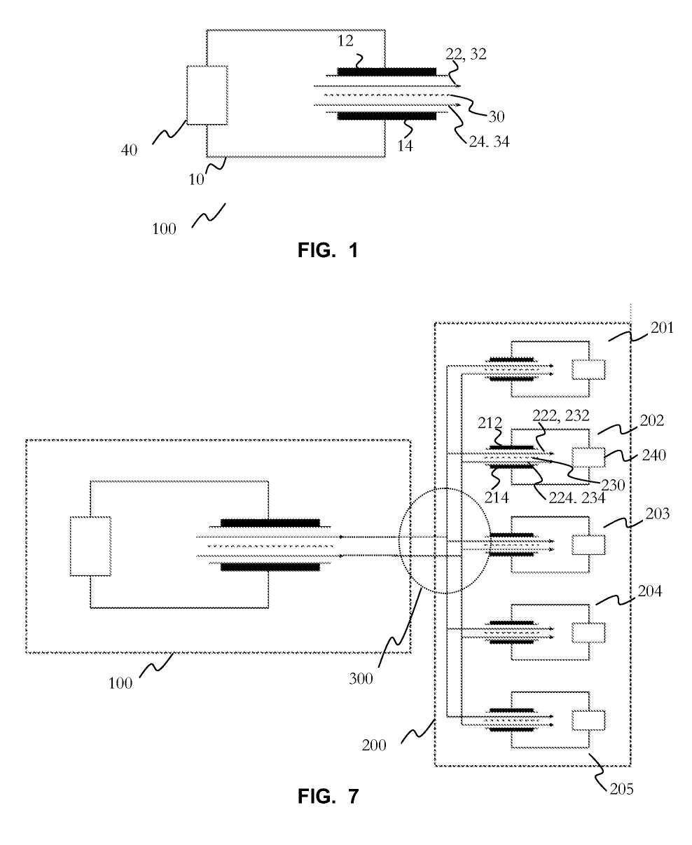

In reference to FIG. 1, an embodiment of an electrochemical voltage regulator element 100 is disclosed, wherein fluid circuits 22 and 24 include respective electrolyte solutions 32 and 34 with dissolved electroactive species therein. There are typically two fluid circuits, although, in other embodiments, only one (physical) fluid circuit is involved, together with co-laminar electrolyte flows, see below. The electrochemical element 100 further includes two electrodes 12 and 14, each contacting respective primary electrolyte solution streams 32 and 34.

In further detail, a first electrode 12 contacts a first electrolyte solution 32 (i.e., filling one of the fluid circuits or half-cell). The solution 32 contains both a primary redox couple and a secondary redox couple, e.g., admixed to the first redox couple in the first electrolyte stream. The electrode is referred to as a polyelectrode and the potential of the polyelectrode is called the mixed potential.

The primary and secondary redox couples are preferably chosen such as to proceed essentially independently at the polyelectrode, which allows for easier control of the conversion of electroactive species. To that aim, the redox couples can be chosen such that the rate of the homogeneous reaction between the primary and secondary redox couples in the solution 32 in contact with the polyelectrode 12 is lower than a heterogeneous reaction rate at the polyelectrode, e.g., by more than one order of magnitude. The two redox couples are then not in equilibrium with each other but proceed independently at the same electrode.

A second electrode 14 (hereafter referred to as a “further” electrode) is in contact with a second electrolyte solution 34, e.g., provided in the second fluid circuit 24. The second electrolyte solution includes a “further” primary redox couple, which shall be further discussed below.

Next, control means 40 are coupled, e.g., via the electrical circuit 10 to the electrodes, to control a concentration of the secondary redox couple. This shall accordingly impact the mixed potential at the polyelectrode, whereby the supply voltage of the electrochemical voltage regulator can be regulated.

Note that electrolyte solutions can be stored externally, which can be for example pumped through the relevant half-cell. Concerning the secondary redox couple admixture, several solutions can be contemplated. The second redox couple can for instance be admixed on the path of the electrolyte solution (containing the primary redox couple) to the regulator 100. A flow battery is accordingly obtained which can be rapidly recharged by replacing the electrolyte liquid and re-energizing the spent material. Thus, the regulator described in reference to FIG. 1 or FIG. 7 may further include additional tanks, fluid circuits, pumps, sensors, control units and the like, as are known in the art. Such additional features are assumed to be conventional and are not depicted in the accompanying drawings.

The principle underlying the present invention exploits the fact that the concentration of redox species in a solution can be influenced with suitable control means, e.g., a control voltage 40 applied at electrodes 12 and 14 in contact with the solutions. By tuning the composition of redox species in solution, a defined and variable supply voltage can be obtained.

This principle is now explained in more details with reference to FIGS. 2-6. Some practical applications of the electrochemical regulator 100 (power supply to electrical consumers) and additional features of preferred electrolyte solutions and suitable redox couples will be discussed with reference to FIG. 7.

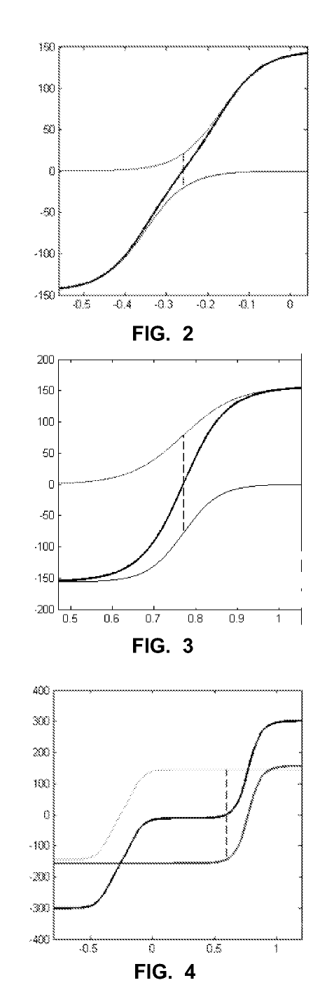

The primary redox couple at the polyelectrode may for instance be V³⁺/V²⁺, in which case its current-potential curve is given in FIG. 2. FIG. 2 depicts the current-potential characteristic of an electrode in contact with V³⁺/V²⁺, for a surface concentration of 0.5/0.5 mol/L. The vertical and horizontal axes respectively represent a current density (A/cm²) and a potential (V vs. SHE, i.e., standard hydrogen electrode). The same conventions shall be used in FIGS. 3-6. In FIG. 2, the oxidation current (positive, upper curve) describes the process V²⁺→V³⁺+e⁻ while the reduction current (negative, lower curve) describes the process V³⁺+e⁻→V²⁺. Under the condition of zero current (open-circuit), the oxidation and reduction currents are equal, which is satisfied at a well-defined potential E₀=−0.26 V (i.e., the vertical dashed line in the figure). The maximum oxidation and reduction currents are defined by the availability of the respective reactant species.

The secondary redox couple considered may for example be Fe³⁺/Fe²⁺, whose current-potential curve is given in FIG. 3, for a surface concentration 0.5/0.5 mol/L. Again, the oxidation current corresponds to the positive, upper curve, and conversely, the reduction current (negative) corresponds to the lower curve. Under the condition of zero current (open-circuit), the oxidation and reduction currents are equal, which is satisfied at E₀=0.77 V (dashed line in FIG. 3).

The current-potential characteristic of the polyelectrode (FIG. 4) in contact with both V₃₊/V₂₊ (surface concentration 0.5/0.5 mol/L) and Fe₃₊/Fe₂₊ (surface concentration 0.5/0.5 mol/L) is a superposition (thick line curve) of the current-potential curves of the primary (upper curve) and the secondary (lower curve) redox couples already shown in FIGS. 2-3. Under open-circuit conditions, the potential of the polyelectrode is the mixed potential Eₘ=0.59 V, as denoted by the dashed line in FIG. 4.

In an electrochemical regulator such as depicted in FIG. 1 (or FIG. 7), tuning the mixed potential can be achieved by altering the relative concentration of species in the secondary redox couple, e.g., altering the concentration of Fe₃₊ and Fe₂₊, in the example of FIGS. 2-4. Electrochemical conversion of Fe₃₊ to Fe₂₊, or vice versa, is a suitable method to alter the relative concentration of Fe₃₊ and Fe₂₊. A further electrode in contact with a further primary redox couple, e.g., VO₂⁺/VO²⁺ (E₀=0.99 V) can be utilized to impose (or receive) a current on an external load (or from a power source). The imposed current may be applied by suitable control means 40, e.g., a power source unit. Meanwhile, a current may be drawn by a load or by discharging the electrolytes across an electrical storage unit. In FIG. 1 (and FIG. 7), the control means and electrical storage are represented by a single unit 40 (and 240). Power source and storage units suited for electrochemical applications are known per se.

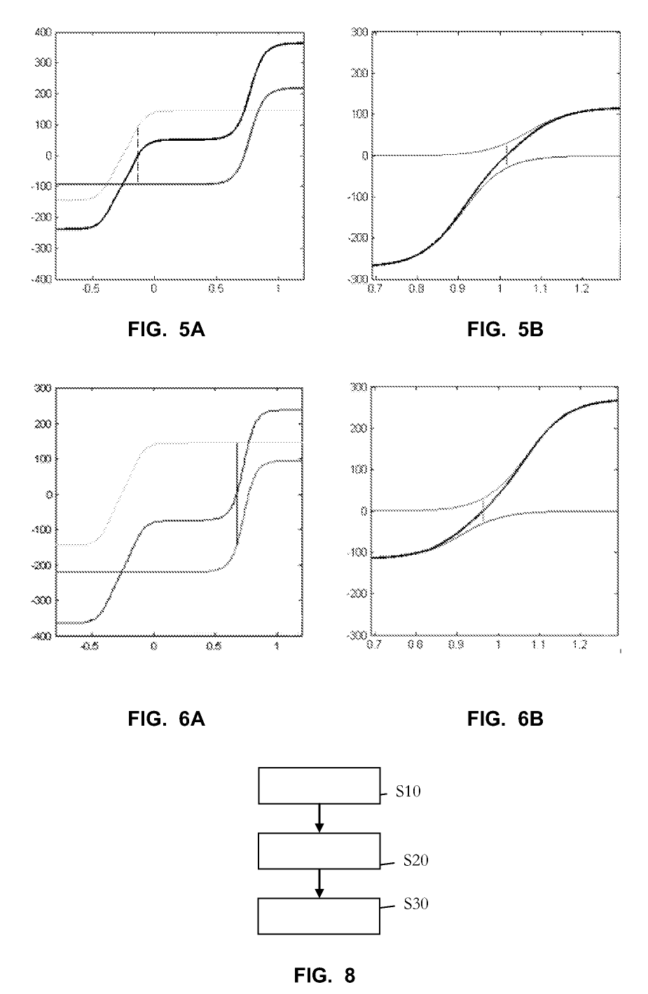

An example of voltage regulation employing the above electrochemical regulator is provided in FIGS. 5 and 6. More precisely, in FIG. 5, a current-potential curve is shown for the polyelectrode (FIG. 5A) and for the further electrode (FIG. 5B). Note that the surface concentrations considered here are 0.5/0.5 for V³⁺/V²⁺, 0.3/0.7 for Fe³⁺/Fe²⁺, and 0.7/0.3 for VO₂⁺/VO²⁺ (in mol/L). The open-circuit voltage is 1.15 V, i.e., the supply voltage of the electrochemical power-delivery system is 1.15 V.

FIG. 6 shows other current-potential curves for the polyelectrode (FIG. 6A) and for the further electrode (FIG. 6B), wherein the surface concentrations are 0.5/0.5 for V³⁺/V²⁺, 0.7/0.3 for Fe³⁺/Fe²⁺, and 0.3/0.7 for VO₂⁺/VO²⁺ (in mol/L). At present, the open-circuit voltage is 0.25 V, i.e., the supply voltage of the electrochemical power-delivery system is 0.25 V.

Thus, for primary redox couples V³⁺/V²⁺ and VO₂⁺/VO²⁺ and secondary redox couple Fe³⁺/Fe²⁺ admixed to the primary redox couple V³⁺/V²⁺, a voltage regulation between 0.25 V and 1.15 V can be obtained. Voltage regulation is obtained by reducing a defined amount of Fe3+ to Fe2+ at the polyelectrode (thereby simultaneously oxidizing VO²⁺ to VO₂⁺ at the further electrode). This conversion can be triggered by application of a voltage signal of about 1.2 V across the polyelectrode and the further electrode. The concentration of the primary redox couple species V³⁺/V²⁺ at the polyelectrode is not changed significantly by this process. With an appropriately selected voltage signal of opposite polarity, Fe²⁺ can be oxidized to Fe³⁺ (thereby simultaneously reducing VO₂⁺ to VO²⁺ at the further electrode), allowing a voltage regulation from 1.15 V to 0.25 V.

Next, an electrochemical voltage regulator such as the one depicted in FIG. 1, and a voltage regulation scheme such as the one described above, can be advantageously used to supply power to electrical consumers, with a defined and adjustable supply voltage, as shown in FIG. 7. A system is thereby defined which includes the electrochemical voltage regulator 100 and a set 200 of one or more electrical consumers 201-205. Each electrical consumer is provided with electrical components reflecting those of the regulator 100, which exploit the power supply thereof. That is, each consumer may be provided with one or more consumer fluid circuits 222 and 224 in fluid communication 300 with respective one or more fluid circuits 22 and 24 of the electrochemical voltage regulator. In addition, electrodes 212 and 214 are provided which contact respective electrolyte solutions 232 and 234 in the consumer fluid circuits. Although electrical consumers benefit from electrochemical power supply as delivered by the electrolyte streams from the unit 100, voltage regulation is determined from control means at the voltage regulator.

The embodiment of FIG. 7 actually corresponds to a parallel configuration, i.e., a derivation unit 300 may for instance be provided to split the streams in output of the regulator 100, such as to feed the various consumers. In variants, a series arrangement can be contemplated, wherein the electrolyte streams outputted from the regulator 100 are fed into a first consumer and so on. A parallel configuration is better suited for powering similar electrical consumers.

Interestingly, in embodiments, at least some of the electrical consumers may include an integrated circuit package. Such a package typically has a layer structure with integrated circuits (ICs) and electrodes arranged in electrical connection with a layer of the layer structure. The package further includes fluid circuit sections, in fluid communication with fluid circuits of the regulator 100. Accordingly, the fluid circuit sections at the IC package can receive respective electrolyte solutions, streamed from the regulator 100. In variants, a single fluid section at the IC package is filled with two distinct electrolyte solutions, in a dual flow redox mode. In all cases, IC package fluid sections are designed to receive and allow one or more electrolyte solutions to contact corresponding electrodes, such as to supply power to the ICs, in operation. As electrodes are integrated to the package, electrical power can be supplied close to the ICs, thereby improving efficiency of the power supply. A high electrical power density can furthermore be achieved, owing to the forced convection of the electrochemical solution contacting the electrodes. Finally, as a liquid is involved in-situ, suitable heat removal can be contemplated, it being noted that electrical power delivery and heat removal needs are congruent. In this respect, the fluid circuits can be optimally designed to substantially cool the ICs. Thus, a combined solution can be achieved which simultaneously solves the problems of supplying electrical power and cooling. Such a solution is particularly well suited for 3D integrated ICs, in which interlayer cooling combines with electrochemical power delivery. Heat removal at rates above 200 W/cm² can be achieved by means of forced convective interlayer cooling in e.g., 3D silicon stacks with pins. In ICs, all electrical power is converted to heat. Thus, as noted above, local cooling and power requirements are congruent, which favors a combined cooling and power delivery. Both heat dissipation and current density provided by an electroactive coolant flow (e.g., pressure-driven) benefit from optimized convective mass transport and increased temperature. Thus, critical resources can be freed. For example, in a 3D stack, the number of through-silicon-vias (TSVs) allocated to power delivery (power vias) can be significantly reduced, thus freeing valuable chip area, reducing wiring congestions and minimizing macro redesign. An increasing number of signal vias can be introduced, thereby improving communication bandwidth. Overall, power-related wiring is furthermore simplified due to the need for on-chip wiring only, avoiding interconnects beyond the chip level.

More generally, the dimensions of the fluid circuits and flow rates of the solutions considered in embodiments already discussed in reference to FIG. 1 or FIG. 7 can be adapted according to the actual electrolyte streams used, electrode types, and power needs of the actual electrical consumers, e.g., in order to optimize the power density, and if needed, heat removal. Should the electrical consumers include IC packages, care should be taken of capillarity phenomena, i.e., minimal interlayer dimensions may need to be considered. On the contrary, capillarity effects can be exploited to favor convection, e.g., using capillary pumps.

From the point of view of chemistry, and independently from the actual electrical consumers 201-205, the basic working principle remains the same as in embodiments described above. For example, referring to FIGS. 1, 7 and 8 altogether, the most general operations performed can be described as follows:
Provided with an electrochemical voltage regulator or a system as described above (step S10 in FIG. 8);
The relative concentration of species of the secondary redox couple is changed (step S20, if needed) in order to modify a mixed potential at the polyelectrode (whereby regulation of supply voltage is obtained). A simple feedback loop can be used to monitor actual needs from the consumers; and
Possibly, the fluid flow rate of the first and second electrolyte solutions can be varied, independently from the voltage set at step S20, to adapt for cooling needs, step S30. Steps S20 and S30 can possibly be interlaced.

The solution 32 (respectively 34) is equipped with multiple redox species, in which case electrode 12 (respectively 14) is a polyelectrode. Physical separation 30 of solutions 32 and 34 is indicated by a dashed line which symbolizes a selective membrane or a co-laminar flow interface (the same is true of physical separation 230 of solutions 232 and 234). The various actors are, again, preferably chosen such that the rate of the homogeneous reaction in solution is slow compared to the heterogeneous reaction rate at the polyelectrode.

In addition, one may want to choose the electroactive species such that:
The equilibrium potential difference of the primary redox couple pair corresponds to the maximum desirable supply voltage of the electrochemical power-delivery system;
The equilibrium potential of the secondary redox couple is:
   More positive than an equilibrium potential of the primary redox couple at a negative electrode of the regulator; and
   Less than an equilibrium potential of the primary redox couple at a positive electrode of the regulator.
In that respect, note that if the (maximum) desirable supply voltage is determined by the primary redox couple pair, the equilibrium potential of the secondary redox couple is preferably located in between the equilibrium potentials of each member of the redox couple pair in order to provide voltage tunability within this desirable supply voltage window. Also, the equilibrium potential of the primary redox couple depends on the concentrations of the oxidized and reduced forms of this redox couple. However, practically this equilibrium potential does not vary by more than ±200 mV;
The mixed potential at the polyelectrode is within the stability range of the supporting electrolyte and solvent. When the mixed potential is outside of the potential window in which the electrolyte solution is stable, irreversible decomposition of the electrolyte solution may occur which can lead to gas and/or deposit formation, thereby reducing performance or causing failure;
The potential at the further electrode is within the stability range of the supporting electrolyte and solvent; and
All species are soluble under the chosen operating conditions.

The additional features recited just above somewhat generalizes the voltage regulation principle described in reference to FIGS. 2-6. With said features in mind, one understands that various triplets of redox couples can be selected amongst Mn³⁺/Mn²⁺ (E₀=1.54 V), Cr⁵⁺/Cr⁴⁺ (E₀=1.34 V), VO₂⁺/VO²⁺ (E₀=0.99 V), Fe³⁺/Fe²⁺ (E₀=0.77 V), (RuO₄)⁻/(RuO₄)²⁻ (E₀=0.59 V), [Fe(CN₆)]³⁻/[Fe(CN₆)]⁴⁻ (E₀=0.36 V), Ru³⁺/Ru²⁺ (E₀=0.24 V), TiOH³⁺/Ti³⁺ (E₀=−0.06 V), V³⁺/V²⁺ (E₀=−0.26 V), Cr³⁺/Cr²⁺ (E₀=−0.41 V), and Ti³⁺/Ti²⁺ (E₀=−0.90 V), see e.g., the CRC Handbook of Chemistry and Physics, 90th edition, 2009-2010.

The equilibrium potential E₀ can be further tuned by selecting appropriate ligands. Note that redox couples such as Mn³⁺/Mn²⁺ (E₀=1.54 V), Cr⁵⁺/Cr⁴⁺ (E₀=1.34 V), and Ti³⁺/Ti²⁺ (E₀=−0.90 V) that could support higher current densities can, in combination with an appropriately selected secondary redox couple, be advantageously used for implementing the present invention. On the contrary, such redox couples would cause water to decompose in usual electrochemical power delivery systems, owing to the tendency toward oxygen evolution above E₀=1.23 V and hydrogen evolution below E₀=0.00 V.

The redox couple may be introduced into the solution in the form of a salt or any suitable derivative, such as a sulfate, chloride, hydroxide, or carbonate. The concentration of the salt should preferably be high enough to provide a high density of electroactive species, e.g., 0.3 mol/L or higher, as illustrated in reference to FIGS. 2-6. The concentration may be lower for miniaturized electrode dimensions due to enhanced rates of diffusion, as is known for microelectrode arrays. The separation distance between the electrodes may be arbitrarily chosen, but should preferably be minimized in order to obtain low ionic resistance of the solution between the electrodes.

Furthermore, one may advantageously use a supporting electrolyte providing sufficient ionic conductivity and that is electro-inactive under the operating conditions of the electrochemical element such as H₂SO₄, Na₂SO₄, K₂SO₄, HCl, KOH, NaOH, NaCl, and KCl.

The solvent should preferably enable high solubility of the salts containing the active redox couples and of the supporting electrolyte. For the species listed above, water is a suitable solvent.

Next, in embodiments, the electrodes may be functionalized to allow specific anode and cathode reactions to take place selectively at the electrodes from within the same solution. Thus, in this case, the “first” and “second” electrolyte solutions, as denoted in the appended claims, may be regarded as two, non-distinct physical streams, yet including species that react with distinct electrodes. This approach may however be difficult to implement for 1 V reactions, due to limited catalytic selectivity. It becomes easier to implement for lower voltages.

Last but not least, the beneficial effects of the electrochemical power supply can be increased when the systems are operated at elevated temperatures as it is needed for direct utilization of thermal energy. Direct use of thermal energy in, e.g., heating applications improves the energetic efficiency of the electric consumers which may be components of a computer system.

Computer program code might be required to implement at least parts of the above invention (e.g. for the fluid convection regulation), which may be implemented in a high-level (e.g., procedural or object-oriented) programming language, or in assembly or machine language if desired; and in any case, the language may be a compiled or interpreted language. Suitable processors include general and special purpose microprocessors. Note that operations that processors perform may be stored on a computer program product tangibly embodied in a machine-readable storage device for execution by a programmable processor; and at least parts of some of the steps involved in this invention may be performed by one or more programmable processors executing instructions to perform corresponding functions.

More generally, the above invention may be at least partly implemented in digital electronic circuitry, or in computer hardware, firmware, software, or in combinations of them. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, flash memory devices or others.

While the present invention has been described with reference to certain embodiments, it will be understood by those skilled in the art that various changes can be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims. For example, the electrodes in contact with the electrolyte solutions may be structured using conventional microstructuring techniques in order to achieve a surface area enlargement as well as enhanced mass transport by diffusion. Additional features such as so-called turbulence promoters may be structured close to the electrodes in order to promote mass transport to the electrodes by convection, which is favorable for high power densities. Also, in embodiments, both electrodes may be polyelectrodes, i.e., a primary redox couple and a secondary redox couple are provided at one electrode and a further primary redox couple and further secondary redox couple are provided at the other electrode. Such a configuration may potentially provide greater flexibility than the configuration generally assumed in the above description, i.e., a polyelectrode and a simple electrode.

What is claimed is:

1. An electrochemical power delivery voltage regulator, comprising:
one or more fluid circuits comprising a first electrolyte solution with a primary redox couple and a secondary redox couple; and a second electrolyte solution with a further primary redox couple;
a polyelectrode in contact with said first electrolyte solution;
a further electrode in contact with said second electrolyte solution; and
control means coupled to said polyelectrode and said further electrode to control a relative concentration of electroactive species of said secondary redox couple and impact a mixed potential at said polyelectrode to regulate a supply voltage of said electrochemical power delivery voltage regulator.

2. The electrochemical power delivery voltage regulator according to claim 1, wherein a rate of a homogeneous reaction between said primary redox couple and said secondary redox couple is substantially less than a heterogeneous reaction rate at said polyelectrode.

3. The electrochemical power delivery voltage regulator according to claim 1, wherein said control means are adapted to impose and draw a current via said polyelectrode and said further electrode.

4. The electrochemical power delivery voltage regulator according to claim 3, wherein said control means comprises both a power source unit and a power storage unit.

5. The electrochemical power delivery voltage regulator according to claim 1, wherein said control means are adapted to apply a first voltage signal across said polyelectrode and said further electrode to reduce an amount of said secondary redox couple, and are further adapted to apply a second voltage signal, having a polarity opposite to said first voltage signal, to oxidize an amount of said secondary redox couple.

6. The electrochemical power delivery voltage regulator according to claim 1, wherein an equilibrium potential difference between said primary redox couple and said further primary redox couple corresponds to a maximum supply voltage of said electrochemical power delivery voltage regulator.

7. The electrochemical power delivery voltage regulator according to claim 1, wherein an equilibrium potential of said secondary redox couple is:
more positive than an equilibrium potential of said primary redox couple at a negative electrode of said regulator; and
less than an equilibrium potential of said primary redox couple at a positive electrode of the regulator.

8. The electrochemical power delivery voltage regulator according to claim 1, further configured to obtain a mixed potential at said polyelectrode, which is within the stability range of said electrolyte and a solvent in contact with said polyelectrode.

9. The electrochemical power delivery voltage regulator according to claim 1, wherein:
the primary redox couple, the secondary redox couple and the further primary redox couple are selected from the couples consisting of: Mn³⁺/Mn²⁺, Cr⁵⁺/Cr⁴⁺, VO₂⁺/VO²⁺, Fe³⁺/Fe²⁺, (RuO₄)⁻/(RuO₄)²⁻, [Fe(CN₆)]³⁻/[Fe(CN₆)]⁴⁻, Ru³⁺/Ru²⁺, TiOH³⁺/Ti³⁺, V³⁺/V²⁺, Cr³⁺/Cr²⁺, and Ti³⁺/Ti²⁺.

10. The electrochemical power delivery voltage regulator according to claim 1, wherein:
said primary redox couple is V³⁺/V²⁺;
said secondary redox couple is Fe³⁺/Fe²⁺; and
said further primary redox couple is VO₂⁺/VO²⁺.

11. The electrochemical power delivery voltage regulator according to claim 1, wherein said regulator comprises one circuit, the regulator being further configured to allow for co-laminar flows of said first and second solutions.

12. The electrochemical power delivery voltage regulator according to claim 1, wherein said regulator comprises two distinct circuits separated by a selective membrane.

13. A system, comprising:
an electrochemical power delivery voltage regulator comprising: one or more fluid circuits comprising a first electrolyte solution with a primary redox couple and a secondary redox couple; and a second electrolyte solution with a further primary redox couple; a polyelectrode in contact with said first electrolyte solution; a further electrode in contact with said second electrolyte solution; and control means coupled to said polyelectrode and said further electrode to control a relative concentration of electroactive species of said secondary redox couple and impact a mixed potential at said polyelectrode to regulate a supply voltage of said electrochemical power delivery voltage regulator;
at least one electrical consumers, each having:
at least one consumer fluid circuits in fluid communication with respective one or more fluid circuits of said electrochemical power delivery voltage regulator; and
electrodes in contact with respective electrolyte solutions in said one or more consumer fluid circuits.

14. The system according to claim 13, wherein at least one of said consumer fluid circuits are in fluid communication with respective one or more fluid circuits of said electrochemical power delivery voltage regulator according to a configuration selected from the group consisting of series and parallel.

15. The system according to claim 13, wherein at least one of said electrical consumers comprises an integrated circuit package having a layer structure, wherein:
said electrodes are arranged on a layer thereof;
integrated circuits are in electrical connection with said electrodes, to supply power to said integrated circuits; and
said at least one more consumer fluid circuits are further designed in accordance with said electrolyte solutions to substantially cool down said integrated circuits in operation.

16. A method of voltage regulation, comprising:
providing an electrochemical power delivery voltage regulator comprising: one or more fluid circuits comprising a first electrolyte solution with a primary redox couple and a secondary redox couple; and a second electrolyte solution with a further primary redox couple; a polyelectrode in contact with said first electrolyte solution; a further electrode in contact with said second electrolyte solution; and control means coupled to said polyelectrode and said further electrode to control a relative concentration of electroactive species of said secondary redox couple and impact a mixed potential at said polyelectrode to regulate a supply voltage of said electrochemical power delivery voltage regulator; and
controlling, via said control means, a concentration of said secondary redox couple to impact a mixed potential applied at said polyelectrode and thereby regulate said supply voltage of said power delivery system.

17. The method according to claim 16, wherein said step of controlling further comprises varying said fluid flow rate of said first and second solutions.
